(19) United States
(12) Patent Application Publication
(10) Pub. No.: US 2025/0083093 A1
(43) Pub. Date: Mar. 13, 2025

(54) VOC ADSORPTION ROTOR

(71) Applicant: Murata Manufacturing Co., Ltd., Nagaokakyo-shi (JP)

(72) Inventors: Yukio SANADA, Nagaokakyo-shi (JP); Teppei KAWAI, Nagaokakyo-shi (JP); Teruhisa SHIBAHARA, Nagaokakyo-shi (JP)

(21) Appl. No.: 18/960,043

(22) Filed: Nov. 26, 2024

Related U.S. Application Data
(63) Continuation of application No. PCT/JP2023/019748, filed on May 26, 2023.

(30) Foreign Application Priority Data
Jun. 3, 2022 (JP) 2022-090686

(51) Int. Cl. B01D 53/06

(52) U.S. Cl. CPC B01D 53/06; B01D 2253/1122; B01D 2255/1021; B01D 2255/1023; B01D 2257/708; B01D 2259/40096

(57) ABSTRACT

A VOC adsorption rotor capable of desorbing an adsorbed VOC with high energy efficiency. The VOC adsorption rotor includes a cellular structure constructed to support an adsorbent to adsorb a VOC. The cellular structure is made of metal.

### CROSS REFERENCE TO RELATED APPLICATIONS

The present application is a continuation of International application No. PCT/JP2023/019748, filed May 26, 2023, which claims priority to Japanese Patent Application No. 2022-090686, filed Jun. 3, 2022, the entire contents of each of which are incorporated herein by reference.

### TECHNICAL FIELD

The present disclosure relates to a VOC adsorption rotor for adsorbing a VOC contained in a process gas.

### BACKGROUND ART

In the related art, honeycomb VOC adsorption rotors that adsorb a volatile organic compound (VOC) (to be referred to as “VOC” hereinafter) are known. Such a conventional VOC adsorption rotor has a base made of, for example, a ceramic or glass material, and supports an adsorbent that adsorbs a VOC. Patent Document 1 discloses a gaseous-substance treatment apparatus including such a VOC adsorption rotor.

The VOC adsorption rotor has the following zones: an adsorption zone in which a VOC contained in a process gas is adsorbed; a desorption zone through which a heated gaseous substance is passed for desorption of the VOC adsorbed in the adsorption zone; and a cooling zone in which the VOC adsorption rotor heated in the desorption zone is cooled. That is, while the VOC adsorption rotor makes one rotation, VOC adsorption is performed in the adsorption zone, VOC desorption is performed in the desorption zone, and cooling is performed in the cooling zone. Then, VOC adsorption is performed again in the adsorption zone.

Patent Document 1: Japanese Unexamined Patent Application Publication No. 2016-77969

### SUMMARY OF THE DISCLOSURE

In conventional VOC adsorption rotors, in order to desorb a VOC that has been adsorbed in the adsorption zone, a gaseous substance is heated, and the heated gaseous substance is passed through the desorption zone. This means that such a VOC adsorption rotor does not have very high energy efficiency for desorbing the VOC, and thus has room for improvement.

The present disclosure is directed to addressing the problem mentioned above. It is accordingly an object of the present disclosure to provide a VOC adsorption rotor capable of desorbing an adsorbed VOC with high energy efficiency.

A VOC adsorption rotor according to the present disclosure includes a cellular structure that supports an adsorbent to adsorb a VOC. The cellular structure is made of metal.

In the VOC adsorption rotor according to the present disclosure, the cellular structure, which supports the adsorbent to adsorb a VOC, is made of metal and thus can be energized. This makes it possible to, for example, directly heat the cellular structure in the desorption zone by passing current through the cellular structure and generating Joule heat. As a result, an adsorbed VOC can be desorbed with high energy efficiency.

### BRIEF DESCRIPTION OF THE DRAWINGS

FIG. 1 schematically illustrates, in perspective view, a configuration of a VOC adsorption rotor according to an embodiment.

FIG. 2 schematically illustrates, in plan view, a configuration of a VOC adsorption rotor according to an embodiment as seen in a direction in which its rotational axis extends.

FIG. 3 illustrates application of voltage with a pair of electrodes that are in contact with the VOC adsorption rotor, and that are disposed in a desorption zone, one each at each outer side portion of the VOC adsorption rotor in a rotational axis direction.

FIG. 4(a) illustrates a first fine geometry reproduction model, which is a model representative of a cellular structure, and FIG. 4(b) illustrates a first homogenous equivalent property model corresponding to the first fine geometry reproduction model.

FIG. 5(a) illustrates a second fine geometry reproduction model, which is a model representative of the cellular structure, and FIG. 5(b) illustrates a second homogenous equivalent property model corresponding to the second fine geometry reproduction model.

FIG. 6(a) is a graph illustrating, with respect to (2Lb/La), normalized electrical conductivity in the X-axis direction and normalized electrical conductivity in the Y-direction, and FIG. 6(b) is a graph in which the vertical axis of the graph in FIG. 6(a) is represented as a logarithmic axis.

FIG. 7(a) illustrates the simulation results on temperature distribution for a case in which the first homogenous equivalent property model is used, FIG. 7(b) illustrates the simulation results on temperature distribution for a case in which the second homogenous equivalent property model is used, and FIG. 7(c) illustrates, in perspective view, four block bodies are stacked top-to-bottom and side-to-side.

### DESCRIPTION OF THE PREFERRED EMBODIMENTS

Characteristic features of the present disclosure are described in more specific detail below with reference to its embodiments.

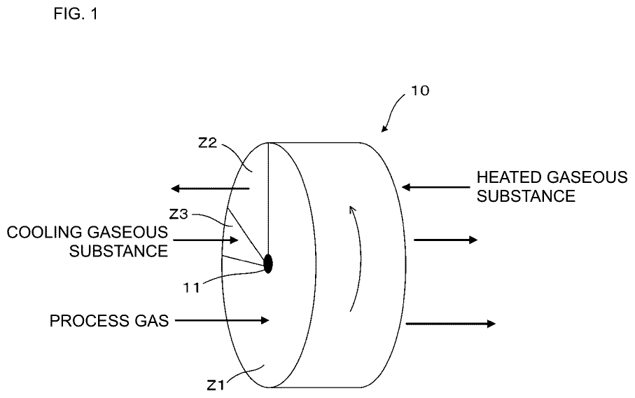

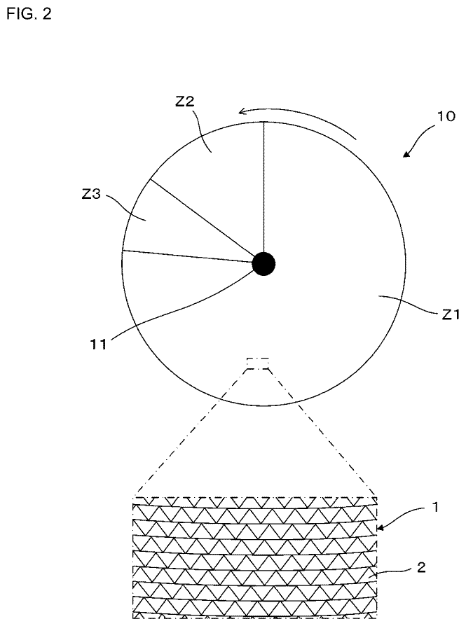

FIG. 1 schematically illustrates, in perspective view, a configuration of a VOC adsorption rotor 10 according to an embodiment. FIG. 2 schematically illustrates, in plan view, a configuration of the VOC adsorption rotor 10 according to an embodiment as seen in a direction in which a rotational axis 11 of the VOC adsorption rotor 10 extends (to be also sometimes referred to as “rotational axis direction” hereinafter).

The VOC adsorption rotor 10 is capable of rotating about the rotational axis 11 with a motor or other devices as its drive source. The VOC adsorption rotor 10 has a diameter of, for example, 500 mm to 2000 mm, and has a dimension of, for example, 200 mm to 800 mm in a direction in which the rotational axis 11 extends.

The VOC adsorption rotor 10 includes a cellular structure 1 supporting an adsorbent to adsorb a VOC. The cellular structure 1 is made of metal such as stainless steel. It is to be noted, however, that the metal constituting the cellular structure 1 is not limited to stainless steel. The VOC adsorption rotor 10 may be entirely made of metal, or a portion of the VOC adsorption rotor 10 other than the honeycomb structure 1 may be made of a material other than a metal.

A plurality of cells 2 constituting the cellular structure 1 may have any shape. In the example in FIG. 2, the cells 2 have a triangular shape as seen in the direction in which the rotational axis 11 extends. The cells 2 may, however, have another shape as seen in the rotational axis direction, such as a hexagonal shape or a rectangular shape.

The adsorbent supported on the cellular structure 1 may be any adsorbent capable of adsorbing a VOC contained in a process gas. Suitable non-limiting examples of the adsorbent include zeolite, activated carbon, and silica. A process gas is, for example, a gas containing a VOC generated in a factory or other places as a result of washing, printing, coating, drying, or other processes. It is to be noted that the kind of the VOC to be removed, or the kind of the adsorbent used does not limit the scope of the present disclosure.

A catalyst for VOC decomposition may be supported on the cellular structure 1. Non-limiting examples of the catalyst for VOC decomposition include platinum and palladium.

As illustrated in FIGS. 1 and 2, the VOC adsorption rotor 10 has an adsorption zone Z1, a desorption zone Z2, and a cooling zone Z3, which are disposed in the direction of rotation. With respect to the direction of rotation, the adsorption zone Z1 occupies an angular range of, for example, 230° to 270°, the desorption zone Z2 occupies an angular range of, for example, 30° to 60°, and the cooling zone Z3 occupies an angular range of, for example, 30° to 60°.

The adsorption zone Z1 is a region through which the process gas is passed for adsorption of a VOC contained in the process gas. The desorption zone Z2 is a region for desorbing the VOC adsorbed in the adsorption zone Z1. To desorb the VOC, a heated gaseous substance is passed through the desorption zone Z2. The cooling zone Z3 is a region for cooling the cellular structure 1 heated in the desorption zone Z2. A gaseous substance for cooling the cellular structure 1 is passed through the cooling zone Z3.

In another example, a gas that has undergone VOC removal by passing through the adsorption zone Z1 may be returned to the emission source of the process gas. In still another example, a gaseous substance that has been warmed by passing through the cooling zone Z3 may be used as the gaseous substance that is to be passed through the desorption zone Z2.

As the VOC adsorption rotor 10 rotates counterclockwise in FIG. 2, the cells 2 located in the adsorption zone Z1 move to the desorption zone Z2 and the cooling zone Z3 in this order before returning to the adsorption zone Z1. At this time, the cellular structure 1 is cooled in the cooling zone Z3, which makes it possible for the cellular structure 1 to adsorb a VOC in the adsorption zone Z1 again.

That is, as the VOC adsorption rotor 10 rotates, adsorption and desorption of a VOC contained in the process gas are performed repeatedly. If a catalyst for VOC decomposition is supported on the cellular structure 1, a VOC decomposition reaction takes place in the desorption zone Z2. Since such VOC decomposition can be regarded as desorption of a previously adsorbed VOC, VOC desorption is herein meant to include VOC decomposition. The VOC adsorption rotor 10 has a rotational speed of, for example, greater than or equal to 8.4 rph to 11.0 rph.

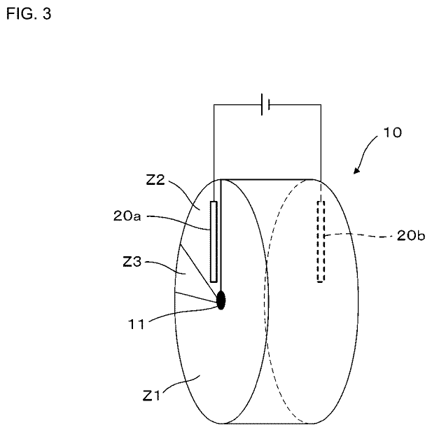

As described above, the cellular structure 1 is made of metal, and thus can be energized. This makes it possible to directly heat the cellular structure 1 in the desorption zone Z2 by passing current through the cellular structure 1 and generating Joule heat. For example, as illustrated in FIG. 3, a pair of electrodes 20a and 20b in contact with the VOC adsorption rotor 10 are disposed in the desorption zone Z2, one each at each outer side portion of the VOC adsorption rotor 10 in the rotational axis direction. As the VOC adsorption rotor 10 rotates, the VOC adsorption rotor 10 rubs against the pair of electrodes 20a and 20b while maintaining its contact therewith. Applying voltage between the pair of electrodes 20a and 20b in this state allows current to pass through the cellular structure 1. As a result, the cellular structure 1 can be heated directly in the desorption zone Z2.

As described above, with the VOC adsorption rotor 10 according to the embodiment, the cellular structure 1 can be heated directly in the desorption zone Z2 by passage of current through the cellular structure 1. This makes it possible to reduce the amount of energy required for VOC desorption. That is, compared with conventional VOC adsorption rotors with which a VOC adsorbed on the cellular structure 1 is desorbed solely by passage of a heated gaseous substance through the desorption zone Z2, the VOC adsorption rotor 10 has improved heating efficiency, which allows the adsorbed VOC to be desorbed with high energy efficiency. For example, in desorbing the VOC adsorbed in the adsorption zone Z1, the temperature to which to heat the gaseous substance to be passed through the desorption zone Z2 can be lowered, as compared with the conventional VOC adsorption rotor mentioned above.

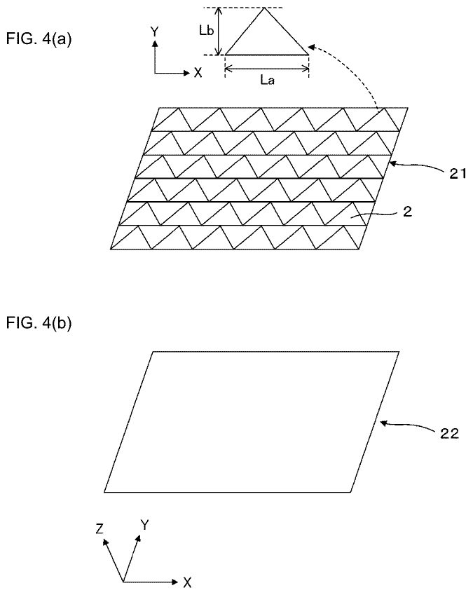

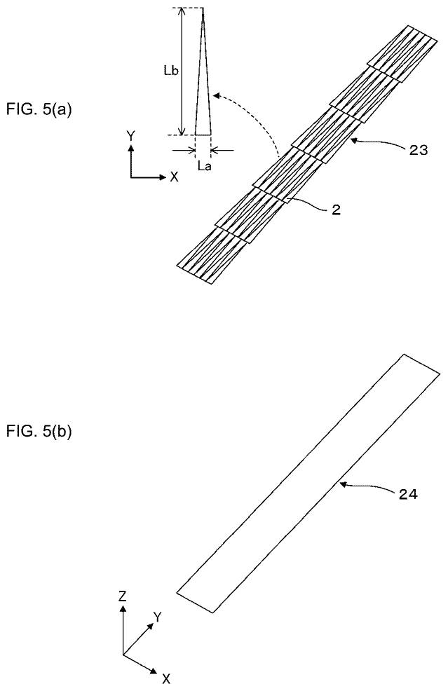

Now, the electrical conductivity of the cellular structure 1 is examined through simulation with varied shape of the cells 2 constituting the cellular structure 1. In this case, to represent cellular structures 1 that differ in the shape of the cells 2, the following two models are created: a first fine geometry reproduction model 21 illustrated in FIG. 4(a); and a second fine geometry reproduction model 23 illustrated in FIG. 5(a). Further, the following models are created for use in the simulation: a first homogenous equivalent property model 22 (FIG. 4(b)), which corresponds to the first fine geometry reproduction model 21; and a second homogenous equivalent property model 24 (FIG. 5(b)), which corresponds to the second fine geometry reproduction model 23.

With respect to the first homogenous equivalent property model 22 illustrated in FIG. 4(b) and the second homogenous equivalent property model 24 illustrated in FIG. 5(b), the X-axis direction, the Y-axis direction, and the Z-axis direction respectively correspond to the circumferential direction, the radial direction, and the rotational axis direction of the VOC adsorption rotor 10.

In the first fine geometry reproduction model 21 illustrated in FIG. 4(a), each cell 2 has a dimension La in the circumferential direction of 3.3 mm, a dimension Lb in the radial direction of 2.0 mm, and a dimension Ld (not illustrated) in the rotational axis direction of 0.05 mm, and the cellular structure 1 has an electrical conductivity o of 1/(142×10⁸) S/m. Table 1 represents the respective resistances in the X-, Y-, and Z-axis directions of the first fine geometry reproduction model 21 and the first homogenous equivalent property model 22, with the dimension in the Z-axis direction of the first homogenous equivalent property model 22 set at 0.1 mm.

TABLE 1

| | Resistance | Resistance | Resistance |
|---|---|---|---|
| | in X-axis | in Y-axis | in Z-axis |
| | direction (Ω) | direction (Ω) | direction (Ω) |
| First fine geometry | 0.605 | 0.546 | 9.762 × 10⁻⁶ |
| reproduction model | | | |
| First homogenous | 0.573 | 0.602 | 9.297 × 10⁻⁶ |
| equivalent property | | | |
| model | | | |

As represented in Table 1, the resistance in the X-axis direction of the first homogenous equivalent property model 22 is within an error of less than or equal to 10% from the resistance in the X-axis direction of the first fine geometry reproduction model 21. Likewise, the resistance in the Y-axis direction of the first homogenous equivalent property model 22 and the resistance in the Z-axis direction of the first homogenous equivalent property model 22 are respectively within an error of less than or equal to 10% from the resistance in the Y-axis direction of the first fine geometry reproduction model 21 and the resistance in the Z-axis direction of the first fine geometry reproduction model 21. Thus, instead of the first fine geometry reproduction model 21, the first homogenous equivalent property model 22, which is a simplified model, can be used for the simulation.

In the second fine geometry reproduction model 23 illustrated in FIG. 5(a), each cell 2 has a dimension La in the circumferential direction of 1.0 mm, a dimension Lb in the radial direction of 10.0 mm, and a dimension Ld (not illustrated) in the rotational axis direction of 0.05 mm, and the cellular structure 1 has an electrical conductivity o of 1/(142×108)S/m. Table 2 represents the respective resistances in the X-, Y-, and Z-axis directions of the second fine geometry reproduction model 23 and the second homogenous equivalent property model 24, with the dimension in the Z-axis direction of the second homogenous equivalent property model 24 set at 0.1 mm.

TABLE 2

| | Resistance | Resistance | Resistance |
|---|---|---|---|
| | in X-axis | in Y-axis | in Z-axis |
| | direction (Ω) | direction (Ω) | direction (Ω) |
| Second fine geometry | 0.287 | 1.524 | 3.868 × 10⁻⁶ |
| reproduction model | | | |
| Second homogenous | 0.270 | 1.493 | 3.752 × 10⁻⁶ |
| equivalent property | | | |
| model | | | |

As represented in Table 2, the resistance in the X-axis direction of the second homogenous equivalent property model 24 is within an error of less than or equal to 10% from the resistance in the X-axis direction of the second fine geometry reproduction model 23. Likewise, the resistance in the Y-axis direction of the second homogenous equivalent property model 24 and the resistance in the Z-axis direction of the second homogenous equivalent property model 24 are respectively within an error of less than or equal to 10% from the resistance in the Y-axis direction of the second fine geometry reproduction model 23 and the resistance in the Z-axis direction of the second fine geometry reproduction model 23. Thus, instead of the second fine geometry reproduction model 23, the second homogenous equivalent property model 24, which is a simplified model, can be used for the simulation.

For the first homogenous equivalent property model 22 and the second homogenous equivalent property model 24, the electrical conductivity in the X-axis direction, the electrical conductivity in the Y-axis direction, and the electrical conductivity in the Z-axis direction are respectively represented by Equations (1) to (3) below.

$$Electric conductivity in X - axis direction = Ld / Lb \times σ [ 1 + 1 / √ ( 1 + {( 2 Lb / La )}^{2} ) ] \qquad ( 1 )$$

$$Electric conductivity in Y - axis direction = Ld / Lb \times σ \times ( 2 Lb / La ) / √ ( 1 + {( La / 2 Lb )}^{2} ) \qquad ( 2 )$$

$$Electric conductivity in Z - axis direction = Ld / Lb \times σ [ 1 + √ ( 1 + {( 2 Lb / La )}^{2} ) ] \qquad ( 3 )$$

The electrical conductivity in the Y-axis direction can be represented by Equation (4) below.

$$Electric conductivity in Y - axis direction = Ld / Lb \times σ \times ( 2 Lb / La ) / [ √ ( 1 + {( La / 2 Lb )}^{2} ) + La / 2 Lb ] \qquad ( 4 )$$

If the electrical conductivity in the X-axis direction and the electrical conductivity in the Y-axis direction are normalized with the electrical conductivity in the Z-axis direction set as 1, then the normalized electrical conductivity in the X-axis direction and the normalized electrical conductivity in the Y-axis direction each depend solely on (2Lb/La).

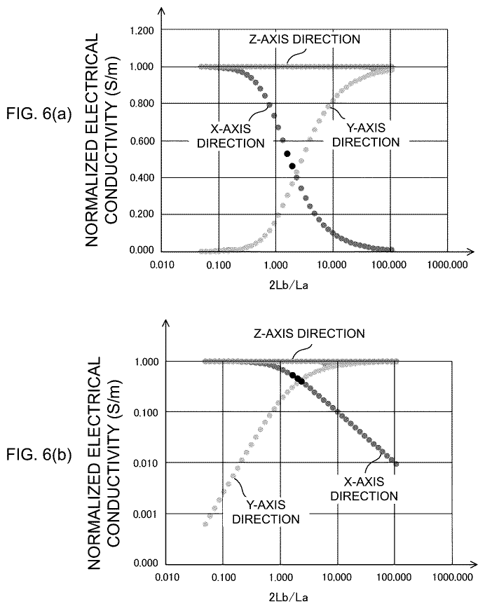

FIG. 6(a) is a graph illustrating, with respect to (2Lb/La), the normalized electrical conductivity in the X-axis direction and the normalized electrical conductivity in the Y-axis direction. FIG. 6(b) is a graph in which the vertical axis of the graph in FIG. 6(a) is represented as a logarithmic axis. In FIG. 6(a) and FIG. 6(b), the horizontal axis is represented as a logarithmic axis. In FIG. 6(a) and FIG. 6(b), the “X-axis direction” represents the normalized electrical conductivity in the X-axis direction, the “Y-axis direction” represents the normalized electrical conductivity in the Y-axis direction, and the “Z-axis direction” represents the normalized electrical conductivity in the Z-axis direction.

As illustrated in FIG. 6(a) and FIG. 6(b), the electrical conductivity in the X-axis direction and the electrical conductivity in the Y-axis direction are less than or equal to the electrical conductivity in the Z-axis direction. The electrical conductivity in the X-axis direction and the electrical conductivity in the Y-axis direction have a trade-off relationship; decreasing the electrical conductivity in one of these directions causes the electrical conductivity in the other direction to increase.

As illustrated in FIG. 3, the amount of heat generated in the radial direction of the VOC adsorption rotor 10 upon application of voltage to the VOC adsorption rotor 10 in the desorption zone Z2 can be adjusted through adjustment of the size of the pair of electrodes 20a and 20b. That is, the amount of heat generated in the radial direction can be increased by use of the pair of electrodes 20a and 20b having a large dimension in the radial direction. This means that if, upon application of voltage to the VOC adsorption rotor 10, a large amount of heat is generated in the circumferential direction of the VOC adsorption rotor 10, which is the direction of rotation, then desorption of an adsorbed VOC can be performed effectively in the desorption zone Z2. The amount of heat generated in the circumferential direction of the VOC adsorption rotor 10 may be increased by decreasing the electrical conductivity in the circumferential direction (X-axis direction). This may be accomplished by increasing (2Lb/La) as illustrated in FIG. 6(a) and FIG. 6 (b). If (2Lb/La) is greater than or equal to 4, the electrical conductivity in the X-axis direction corresponding to the circumferential direction is lower than the electrical conductivity in the Y-axis direction corresponding to the radial direction. Accordingly, (2Lb/La) is preferably greater than or equal to 4, that is, Lb/La is preferably greater than or equal to 2. If (2Lb/La) is greater than or equal to 6, the electrical conductivity in the X-axis direction corresponding to the circumferential direction becomes even lower. Accordingly, it is more preferable that Lb/La be greater than or equal to 3.

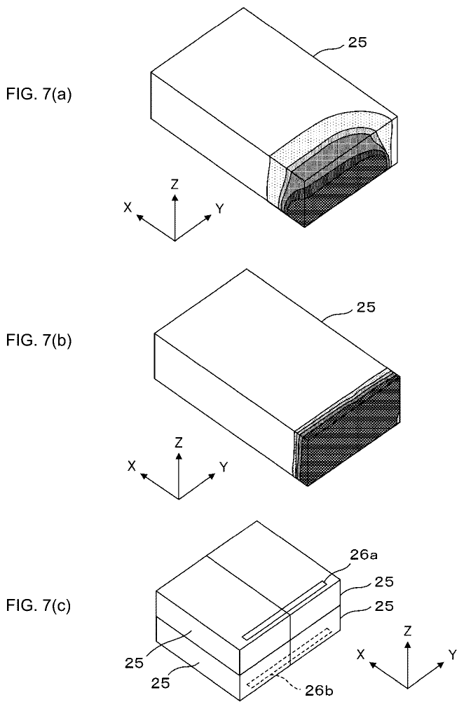

FIG. 7 illustrates the simulation results on the temperature distribution of the cellular structure 1 when voltage is applied to the pair of electrodes 20a and 20b in contact with the VOC adsorption rotor 10 as illustrated in FIG. 3, of which FIG. 7(a) illustrates the temperature distribution for a case in which the first homogenous equivalent property model 22 is used, and FIG. 7(b) illustrates the temperature distribution for a case in which the second homogenous equivalent property model 24 is used.

In this case, as illustrated in FIG. 7(c), four block bodies 25 employing the first homogenous equivalent property model 22 or the second homogenous equivalent property model 24 are stacked top-to-bottom and side-to-side, and the temperature distribution when voltage is applied to a pair of electrodes 26a and 26b disposed at opposite positions in the Z-axis direction on the four block bodies 25 is examined. The block body 25 illustrated in each of FIG. 7(a) and FIG. 7(b) represents the lower right one of the four block bodies 25 illustrated in FIG. 7(c). In the temperature distribution illustrated in each of FIG. 7(a) and FIG. 7(b), more intensely-colored regions indicate higher temperatures. That is, dark-colored regions indicate temperatures higher than those in light-colored regions.

As illustrated in FIG. 7(a) and FIG. 7(b), when the second homogenous equivalent property model 24 is used, high temperature regions extend over a wide area, and the temperatures in the X-axis direction corresponding to the circumferential direction are high over a wide area, as compared with when the first homogenous equivalent property model 22 is used. That is, for effective desorption of an adsorbed VOC, the second fine geometry reproduction model 23 (FIG. 5(a)) whose Lb/La is 10 is preferred to the first fine geometry reproduction model 21 (FIG. 4(a)) whose Lb/La is approximately 0.6.

Although the simulation mentioned above assumes that each cell 2 has a triangular shape as seen in the direction in which the rotational axis 11 extends, the same applies to when each cell 2 has a hexagonal or rectangular shape. In such a case as well, Lb/La is preferably greater than or equal to 2, or more preferably greater than or equal to 3.

The present disclosure is not limited to the embodiments mentioned above but allows various alterations and modifications to be made within the scope of the present disclosure.

The VOC adsorption rotor according to the present application is as follows.
<1>. A VOC adsorption rotor including a cellular structure constructed to support an adsorbent to adsorb a VOC, in which the cellular structure is made of metal.
<2>. The VOC adsorption rotor according to <1>, in which when cells constituting the cellular structure each have a dimension La in a circumferential direction, and a dimension Lb in a radial direction, Lb/La is greater than or equal to 2.
<3>. The VOC adsorption rotor according to <1>, in which when cells constituting the cellular structure each have a dimension La in a circumferential direction, and a dimension Lb in a radial direction, Lb/La is greater than or equal to 3.
<4>. The VOC adsorption rotor according to <2> or <3>, in which as seen in a direction in which a rotational axis of the VOC adsorption rotor extends, each of the cells is triangular in shape.
<5>. The VOC adsorption rotor according to any one of <1> to <4>, in which the metal is stainless steel.

### Reference Signs List

1 cellular structure
2 cell
10 VOC adsorption rotor
11 rotational axis
20a, 20b pair of electrodes
21 first fine geometry reproduction model
22 first homogenous equivalent property model
23 second fine geometry reproduction model
24 second homogenous equivalent property model
25 block body
26a, 26b pair of electrodes
Z1 adsorption zone
Z2 desorption zone
Z3 cooling zone

1. A VOC adsorption rotor comprising:
a cellular structure constructed to support an adsorbent to adsorb a VOC,
wherein the cellular structure is made of metal.

2. The VOC adsorption rotor according to claim 1, wherein when cells constituting the cellular structure each have a dimension La in a circumferential direction, and a dimension Lb in a radial direction, Lb/La is greater than or equal to 2.

3. The VOC adsorption rotor according to claim 2, wherein as seen in a direction in which a rotational axis of the VOC adsorption rotor extends, each of the cells is triangular in shape.

4. The VOC adsorption rotor according to claim 1, wherein when cells constituting the cellular structure each have a dimension La in a circumferential direction, and a dimension Lb in a radial direction, Lb/La is greater than or equal to 3.

5. The VOC adsorption rotor according to claim 4, wherein as seen in a direction in which a rotational axis of the VOC adsorption rotor extends, each of the cells is triangular in shape.

6. The VOC adsorption rotor according to claim 1, wherein the metal is stainless steel.

7. The VOC adsorption rotor according to claim 1, further comprising a catalyst for VOC decomposition supported on the cellular structure.

8. The VOC adsorption rotor according to claim 7, wherein the catalyst for VOC decomposition is platinum or palladium.

9. The VOC adsorption rotor according to claim 1, wherein the VOC adsorption rotor has an adsorption zone, a desorption zone, and a cooling zone, which are disposed in a direction of rotation of the VOC adsorption rotor.

10. The VOC adsorption rotor according to claim 9, wherein, with respect to the direction of rotation, the adsorption zone occupies an angular range of 230° to 270°, the desorption zone occupies an angular range of 30° to 60°, and the cooling zone Z3 occupies an angular range of 30° to 60°.

11. The VOC adsorption rotor according to claim 9, further comprising a pair of electrodes in contact with the VOC adsorption rotor in the desorption zone such that, as the VOC adsorption rotor rotates and voltage is applied between the pair of electrodes, current passes through the cellular structure to directly heat the desorption zone.
